(19) United States
(12) Patent Application Publication
(10) Pub. No.: US 2025/0036114 A1
(43) Pub. Date: Jan. 30, 2025

(54) AUTOMATION OF DEFECT RECOGNITION USING LARGE FOUNDATION MODEL

(71) Applicant: Schlumberger Technology Corporation, Sugar Land, TX (US)

(72) Inventors: Josselin Kherroubi, Clamart (FR); Kamaljeet Singh, Bucharest (RO); Eya Ghamgui, Clamart (FR); Imane Baho, Clamart (FR)

(21) Appl. No.: 18/783,519

(22) Filed: Jul. 25, 2024

Related U.S. Application Data
(60) Provisional application No. 63/515,595, filed on Jul. 26, 2023.

(51) Int. Cl. G05B 23/02

(52) U.S. Cl. CPC G05B 23/0243

(57) ABSTRACT

Embodiments presented provide for a method for defect recognition for pipes used in hydrocarbon recovery operations. In embodiments, a large foundation model is used to help automatically detect and characterize the defects, eliminating the need for expert analysis.

### CROSS-REFERENCE TO RELATED APPLICATIONS

The present application claims priority to U.S. Provisional Patent Application 63/515,595, filed Jul. 26, 2023, the entirety of which is incorporated by reference.

### FIELD OF THE DISCLOSURE

Aspects of the disclosure relate to defect recognition in pipes. More specifically, aspects of the disclosure relate to recognition of defects in hydrocarbon recovery pipes through use of a large foundation model.

### BACKGROUND

Steel pipes used to secure wells are subject to corrosion and wear factors that can have serious impacts on the stability and durability of wells. To combat these potential impacts, corrosion mapping tools (either with ultrasonic or mechanical sensors-calipers) aim at detecting and capturing different shapes and sizes of corrosion defects along the pipes. The approach; however, still heavily relies on manual defect picking.

Recognition of defects in piping systems for hydrocarbon recovery systems is typically performed by a domain expert. This is a long and interpreter dependent process. Accelerating or automating this task reduces the cost of operation and enables the operator to focus on tasks requiring more expertise.

Recent methods have emerged using deep learning. The construction of this type of model is nevertheless long: requiring extensive annotation of cuttings by a domain expert (with consistency check, etc.), designing of the model, testing. These conventional methods are cumbersome and it is difficult to achieve a model that could generalize for any type of formation (diverse geology) or is robust to environmental variations (illumination, wet cuttings, etc.)

There is a need to provide an apparatus and methods that are easier to operate than conventional apparatus and methods and will provide recognition of defects such that extensive use of expert analysis is minimized.

There is a further need to provide apparatus and methods that do not have the drawbacks discussed above, namely long and complicated review times and the potential for human error.

There is a still further need to reduce economic costs associated with operations and apparatus described above with conventional tools while providing quick analysis of field conditions.

There is a still further need to provide on-sight identification of defects without the lag time of taking data and analyzing the data at a laboratory.

### SUMMARY

So that the manner in which the above recited features of the present disclosure can be understood in detail, a more particular description of the disclosure, briefly summarized below, may be had by reference to embodiments, some of which are illustrated in the drawings. It is to be noted that the drawings illustrate only typical embodiments of this disclosure and are; therefore, not to be considered limiting of its scope, for the disclosure may admit to other equally effective embodiments without specific recitation. Accordingly, the following summary provides just a few aspects of the description and should not be used to limit the described embodiments to a single concept.

In one embodiment of the disclosure a method of automated defect recognition is disclosed. The method may comprise receiving a set of data related to a piping formation. The method may also comprise preparing a visual representation of the data. The method may also comprise placing at least one positive data point on the visual representation. The method may also comprise placing at least two negative data points on the visual representation. The method may also comprise feeding data of the at least one positive data point, the at least two negative data points and visual representation of the data into a Large Foundation Model. The method may also comprise producing a mask with the Large Foundation Model, wherein the mask identifies defects in the data.

In another example embodiment, an article of manufacture configured to contain a set of instructions that are readable by a computer is disclosed. The article of manufacture configured on a non-volatile memory. The set of instructions are configured to perform receiving a set of data related to a piping formation and preparing a visual representation of the data. The set of instructions further configured for placing at least one positive data point on the visual representation. The set of instructions further configured for placing at least two negative data points on the visual representation. The set of instructions further configured for feeding data of the at least one positive data point, the at least two negative data points, and visual representation of the data into a Large Foundation Model. The set of instructions further configured for producing a mask with the Large Foundation Model, wherein the mask identifies defects in the data.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the drawings. It is to be noted; however, that the appended drawings illustrate only typical embodiments of this disclosure and are; therefore, not be considered limiting of its scope, for the disclosure may admit to other equally effective embodiments.

FIGS. 1A and 1B are thickness and radius maps from a USIT tool (A) and UCI tool (B) with manufacturing patterns.

FIGS. 2A and 2B are a thickness maps from a USIT tool (A) and UCI tool (B) with weld (along the long axial line).

FIG. 3 is a graph of good condition pipes with manufacturing patterns.

FIG. 4 is a graph of pipes presenting defects and manufacturing patterns.

FIG. 5A-D are examples of a patch from a THBK image (A), wherein in (B) three positive points are placed at three different depths and 6 corresponding negative points, and (C) presents a mask plotted on the image and wherein (D) is a manually created mask.

FIG. 6A-D are examples of a patch from a THBK image (A), wherein (B) three positive points are added in three different depths and 6 corresponding negative points, and wherein in (C) a mask is plotted on the image and (D) a manually created mask is plotted on the image.

FIGS. 7A and 7B are examples of two THBK images, wherein in (A) the original image is illustrated, in the center a manual mask is presented and in the right column, the pre-processed image.

FIG. 8A-C shows examples of THBK images with a comparison between a manual mask and a fine-tuned mask. In FIGS. 8A, 8B and 8C, the left column corresponds to the original image, the middle column corresponds to the image with the manual mask and the right column corresponds to the image with the fine-tuned mask.

FIG. 9 is a zoomed area of the image of FIG. 8C.

FIG. 10 is an example of a THBK image where in the left column corresponds to the original image, the middle column corresponds to the image with the boxed mask and the right column corresponds to the image with the fine-tuned mask.

FIG. 11 is an example of an annotated tool display.

FIG. 12 is a display after adding points to the image, wherein these points delineate the area of the mask to be dined around the defect.

FIG. 13 is a display after creating the manual mask and corresponding plotting of the mask.

FIG. 14 is a is a display after fine-tuning the mask, wherein a comparison between the manually created mask and the fine-tuned mask is illustrated.

FIG. 15 is an appearance of the annotated tool.

FIG. 16 is an example of a method of analysis of a pipe in one example embodiment of the disclosure.

To facilitate understanding, identical reference numerals have been used, where possible, to designate identical elements that are common to the figures (“FIGS”). It is contemplated that elements disclosed in one embodiment may be beneficially utilized on other embodiments without specific recitation.

### DETAILED DESCRIPTION

In the following, reference is made to embodiments of the disclosure. It should be understood; however, that the disclosure is not limited to specific described embodiments. Instead, any combination of the following features and elements, whether related to different embodiments or not, is contemplated to implement and practice the disclosure. Furthermore, although embodiments of the disclosure may achieve advantages over other possible solutions and/or over the prior art, whether or not a particular advantage is achieved by a given embodiment is not limiting of the disclosure. Thus, the following aspects, features, embodiments and advantages are merely illustrative and are not considered elements or limitations of the claims except where explicitly recited in a claim. Likewise, reference to “the disclosure” shall not be construed as a generalization of inventive subject matter disclosed herein and should not be considered to be an element or limitation of the claims except where explicitly recited in a claim.

Although the terms first, second, third, etc., may be used herein to describe various elements, components, regions, layers and/or sections, these elements, components, regions, layers and/or sections should not be limited by these terms. These terms may be only used to distinguish one element, components, region, layer or section from another region, layer or section. Terms such as “first”, “second” and other numerical terms, when used herein, do not imply a sequence or order unless clearly indicated by the context. Thus, a first element, component, region, layer or section discussed herein could be termed a second element, component, region, layer or section without departing from the teachings of the example embodiments.

When an element or layer is referred to as being “on,” “engaged to,” “connected to,” or “coupled to” another element or layer, it may be directly on, engaged, connected, coupled to the other element or layer, or interleaving elements or layers may be present. In contrast, when an element is referred to as being “directly on,” “directly engaged to,” “directly connected to,” or “directly coupled to” another element or layer, there may be no interleaving elements or layers present. Other words used to describe the relationship between elements should be interpreted in a like fashion. As used herein, the term “and/or” includes any and all combinations of one or more of the associated listed terms.

Some embodiments will now be described with reference to the figures. Like elements in the various figures will be referenced with like numbers for consistency. In the following description, numerous details are set forth to provide an understanding of various embodiments and/or features. It will be understood; however, by those skilled in the art, that some embodiments may be practiced without many of these details, and that numerous variations or modifications from the described embodiments are possible. As used herein, the terms “above” and “below”, “up” and “down”, “upper” and “lower”, “upwardly” and “downwardly”, and other like terms indicating relative positions above or below a given point are used in this description to more clearly describe certain embodiments.

In aspects, a model is presented to evaluate data from a pipe or piping system for the purpose of identifying defects in the piping system. In embodiments, the evaluation may be done through an autonomous system that identifies the defects and eliminates the requirements of a domain expert from having to review the logs obtained from field personnel. By eliminating high-cost experts, the maintenance activities of the piping system may be accomplished in fractions of the time and cost of conventional methods.

Aspects of the disclosure are also superior to so-called “deep learning” algorithms that have problems recognizing differences in very fine visually depicted features. Such deep learning algorithms have a significant problem of being unable to generalize for different types of formations, thus each deep learning algorithm model must be created for a specific purpose. Creation of site-specific models; therefore, are required for such “deep learning” models, causing extra amounts of capital to be expended on each project. As a result of such necessary creations, such models are inferior to the methodologies presented herein.

Aspects of the disclosure provide a model that allows for defect identification and quantification. The model may be pre-trained in some aspects of the disclosure. If the model is not producing expected results, the model may be retrained. In some aspects, the disclosure proposes alternative methods using a Large Foundation model (LFM). Such Large Foundation Models do not require any training (zero shot learning) and enable active annotation to manage the generalization. As will be understood, the model may be updated through retraining, as necessary.

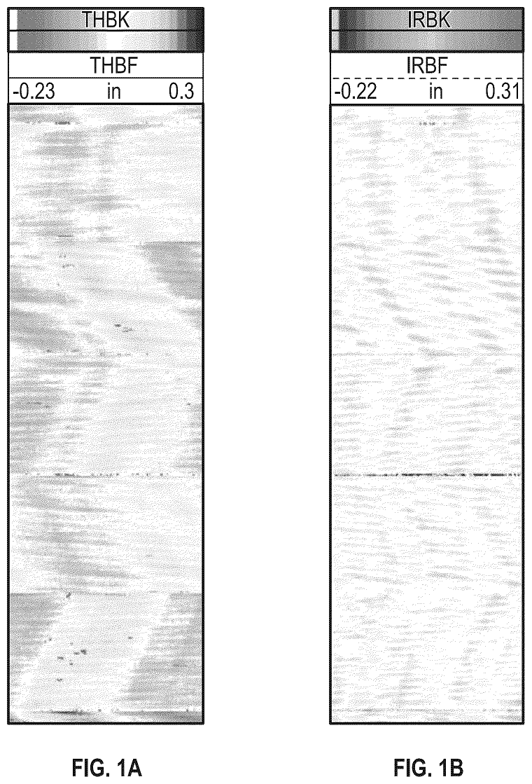

First, data may be obtained from the use of ultrasonic transducers, for example, that send and receive signals into a pipe. The data sent and received is recorded for analysis. In one embodiment, the data may be visually displayed. This visual display of data may be, for example, along an axis of the extending piping. In some embodiments, the input data consists of thickness or radius distribution maps of the pipe around their respective mean values. The values obtained directly reflect the amount of metal loss or excess in the pipe. The data can be represented as images containing corrosion and other features, as illustrated in FIG. 1.

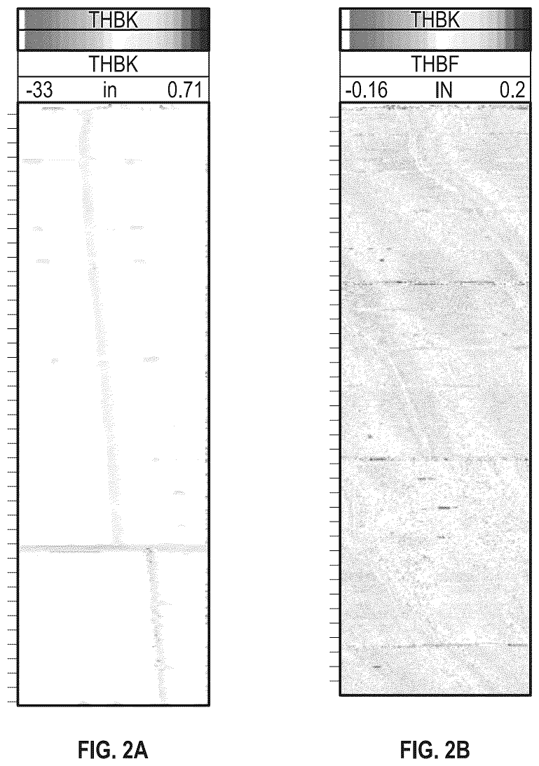

In one example the data may contain different features. In this non-limiting embodiment, the data contains:
Macro Features: or “background” represents changes of wall thickening and thinning caused by the process of manufacturing such as a machining process: by molding as presented in FIG. 1 or welding as in FIG. 2.
Micro features:
   Collars: intermediate areas (or links) between joints, contain extreme values and are not regular (due to manufacturing processes).
   Defects: corrosion and wear of the pipe (loss in metal).
Noise: in some high-resolution tools, the data is noisy-images have additional features with no physical significance (only noise points).

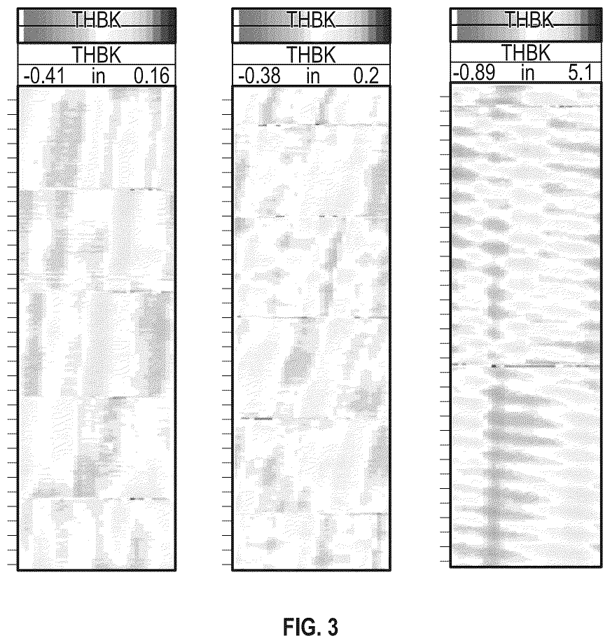

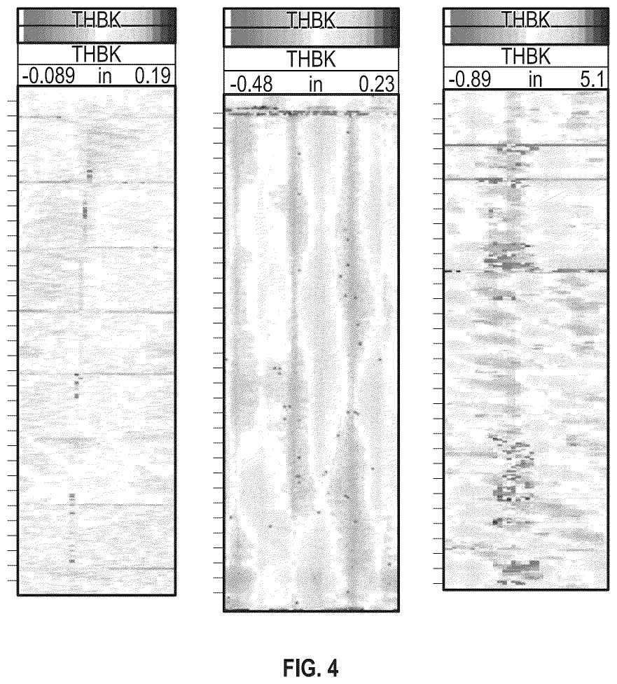

For purposes of illustration, a scan of pipes in good condition is illustrated in FIG. 3. Corrosion defects may have varied shapes and sizes from: pits, localized defects to axial grooves, as seen in FIG. 4.

Aspects of the disclosure provide for an output from the methodologies disclosed that would allow for identification of anomalies. The output of the disclosure would be to:
First, detect and discriminate those anomalies from all other features described previously and provide their location in the map.
Second, compute their dimensions: axial length, circumferential width and depth of penetration.

Examples will now be used to explain the method steps involved. As will be understood, the method may be used to not only detect and discriminate anomalies related to corrosion, but also for other defects. Such defects may be from mechanical contact, such as abrasion, gouging and impact.

Annotation of Visual Data with a Large Foundation Model

In one embodiment, a Large Foundation Model is used to produce masks that delineate a groove area in an image. The Large Foundation Model may be a pre-trained model. The pre-trained model may allow for analyzation of visual data produce masks that delineate the groove area in an image using only a few mouse clicks. These masks are created for use in other deep learning applications and will serve as ground truth for the models. In one embodiment, the following steps are involved in creating the mask:
1) On a left mouse click, positive point is added (yellow; positive point is a point inside the area to segment).
2) On a right click: negative point is added (red; negative point is a point in a region outside the defect). The negative point can be used to restrict the area where the defect should be segmented. This provides a local constraint for analysis.
3) The backspace key is used to remove all the points (negative and positive).
4) The enter key is used to segment.

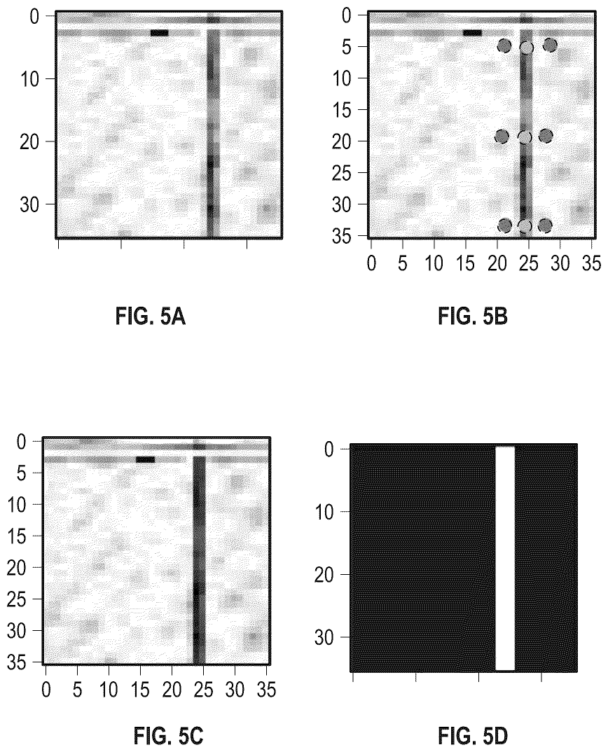

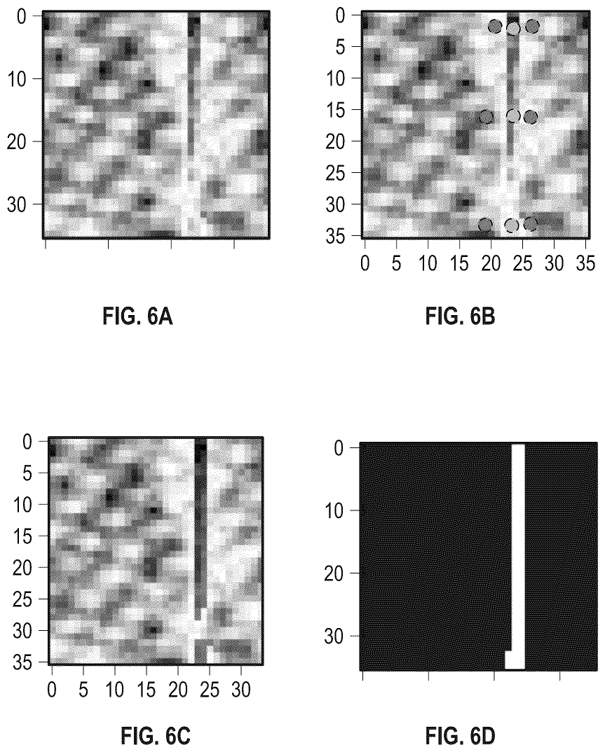

By using this annotation approach described above, much of the task for analysis is competed. In a hypothetical method for an image, the amount of annotation would be 3×3=9 clicks (3 clicks for each depth, as the visual representation uses 1 positive and 2 negative points). With the above, masks are generated for defects identification in images, as shown in FIGS. 5 and 6, which significantly reduce the manual annotation effort and time required to identify the concerned pixels. Conventionally, this task is sensitive and requires a significant amount of time to be completed with precision. With the method described herein with the Large Foundation Model, the same task is performed faster and with higher precision than a hand-created mask. FIG. 6 shows how the mask created by one example Large Foundation Model (c) is more precise than the manually created mask (d), especially at the bottom of the image where no defect is present. To summarize, this technique offers several benefits, including faster and more efficient creation of masks for groove defects, reduced workload and effort, and improved precision in defect detection.

### Annotation Using Existing Ground Truth

As described above, it was assumed that the logs had not been interpreted. In another application of the method, logs that have been interpreted may be further enhanced. Such annotations may increase the consistency of recurring defects within an existing database with annotations. Thus, an entire section of a database that contains logs may be reviewed quickly and efficiently. Such activities are beneficial because costs of review are expensive from both a monetary and time perspective. It is noted that:
annotations are dependent on the user and require a significant amount of expertise; and
models are highly sensitive to annotation quality.

In this example methodology, non-precise annotated data for which we have manually defined masks for the images is reviewed. A Large Foundation Model is used to fine-tune these annotations. In these embodiments, the manual mask is used as a set of prior information for the groove position and will serve as a starting point for creating the negative and positive points of the model. This is similar to the methodology described above. In this methodology; however, rather than the human selecting these points, the manual mask will determine the position of the negative and positive points. The manual mask is used to apply a pre-processing to the image to improve the performance and the accuracy of the Large Foundation Model. Details of the methodology are explained below.

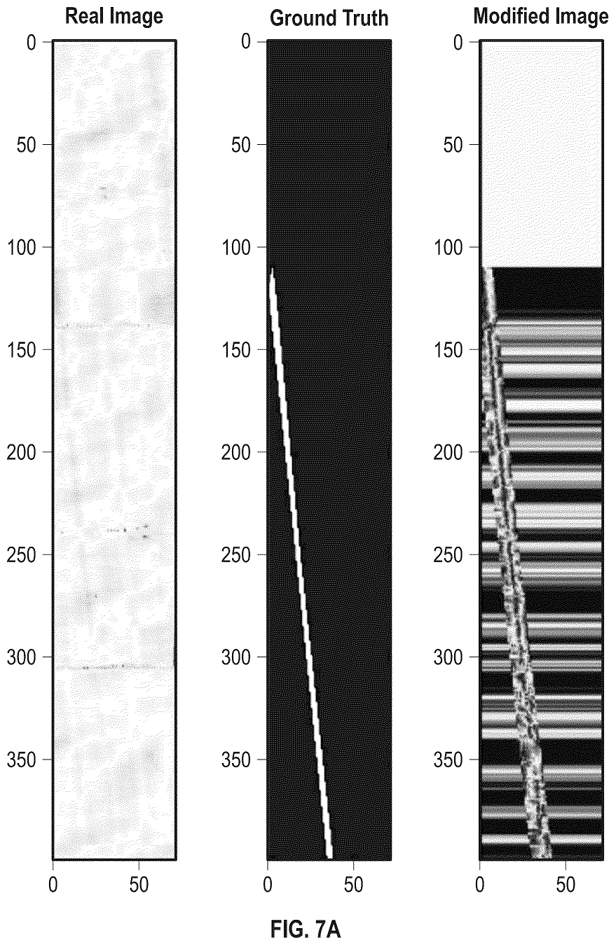

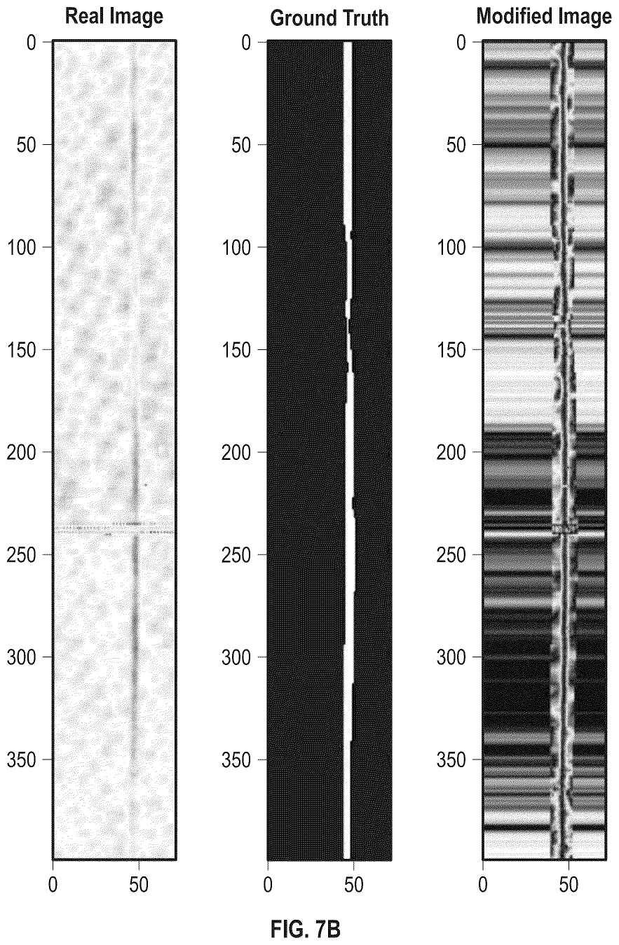

In a pre-processing step, an enlarged area around the defect is kept and the background is replaced (the undetected area in the manual mask) with a median of the background. This pre-processing step reduces the impact of the background intensity values on the defect area as this area may share intensity values with the background. In a second step, the lines containing the defects are normalized using a min-max normalizer. The second step locally highlights the defects and creates a larger gap between the intensity values of the defect and the background. FIG. 7 shows how the method better highlights the defects in the image, even though they are barely visible to the eye (FIG. 7A). This method allows for creation of a better contrast between the defects and the background, and will help the Large Foundation Model detect grooves, even in the most difficult cases.

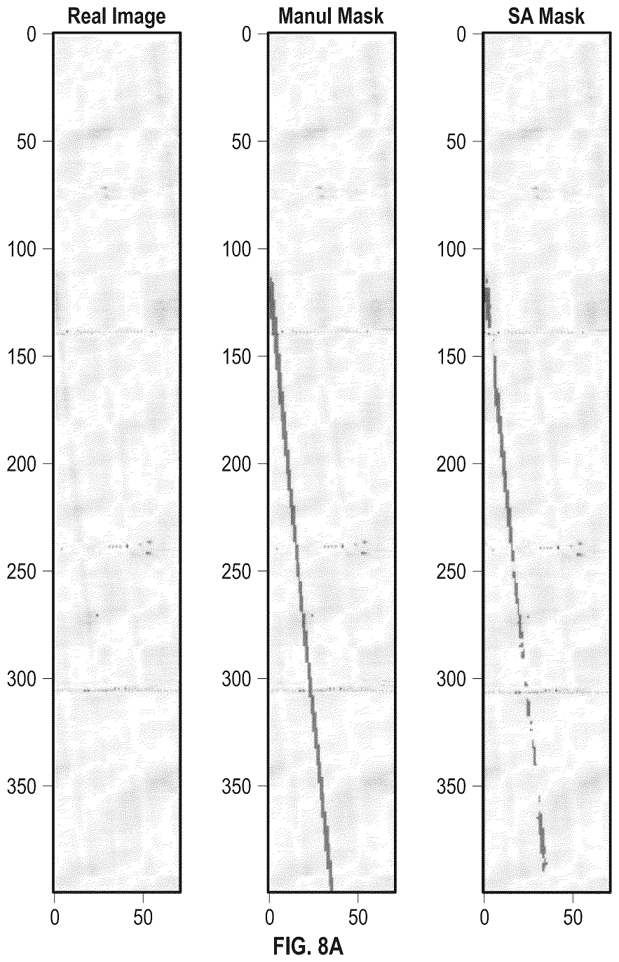

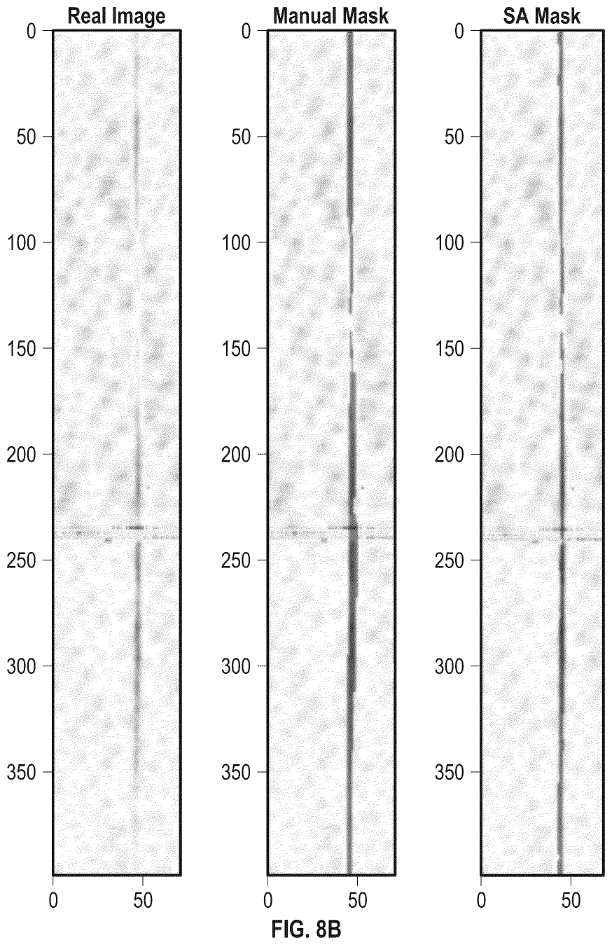

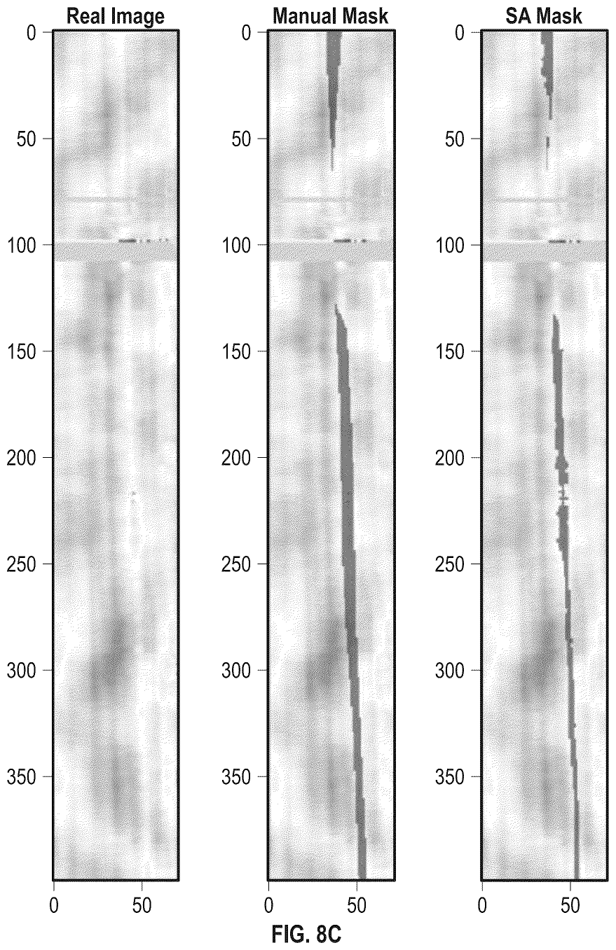

The process of generating the masks may be done in sections or patches. In order to have a compromise between the computational time and performance, a patch size of 50 rows is chosen. More or less numbers of rows may be chosen. The choosing may be through user input or may be done by artificial intelligence. To apply the LFM, positive and negative points are next chosen. In embodiments, five positive points are selected as well as ten negative points. The number of the positive and negative points may be altered. The five positives are chosen from the rows with detections in the manual mask. In that row, the point with the lowest intensity value in the grayscale range is chosen, since the intensities of the defects are the lowest. The negative points are selected from the background area on the same rows, with a margin of 3 pixels from the mask's extremities. The output of the model is depicted in FIG. 8. The created masks are a fine-tuned version of the manual mask, which with more precision, represents the groove in the image.

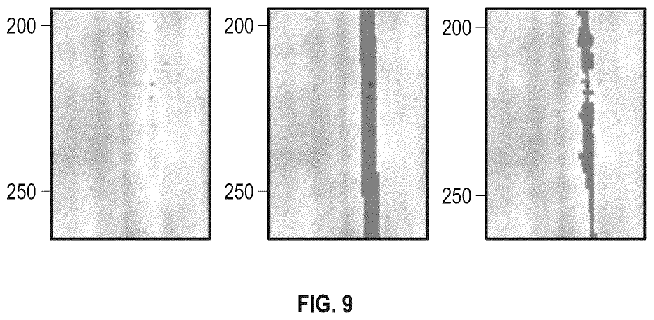

When zooming into the image in FIG. 8C and (FIG. 9), the mask displays significantly better precision than the user-created mask, demonstrating the power of the model. This technique proves useful in minimizing the errors and biases typically associated with human-created annotations.

### Annotation Using Manual Selection of Boxes

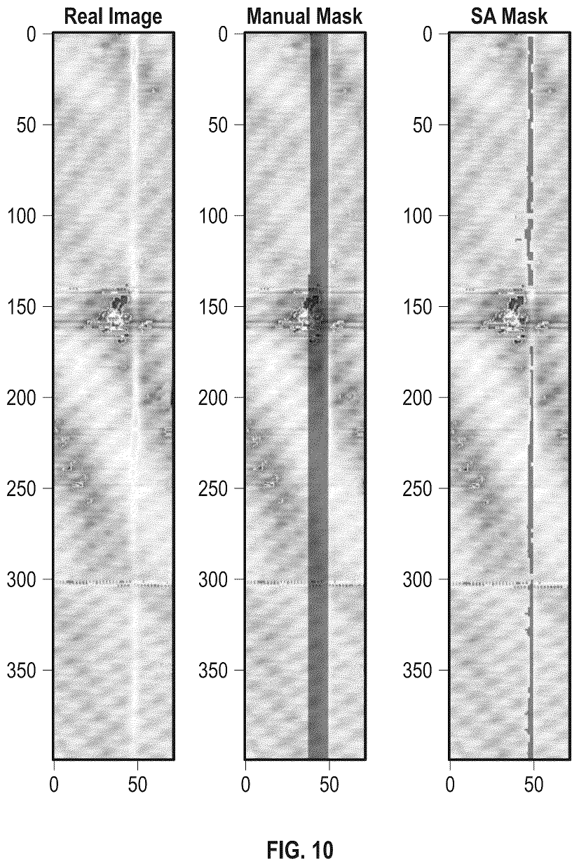

In some method steps or previous activities, bad initial annotations may have occurred, such as from manual annotation. Aspects of the disclosure; however, are able to take initial annotations that are defective and provide further annotations using a mask generated from boxes created on a video screen. In these embodiments, the mask was created using manually selected points surrounding the defect, forming a polygon. As seen in FIG. 10, the model was able to yield satisfactory results for detecting groove defects.

### Annotation Tool

In embodiments, the annotation tool combines all the techniques discussed above. It is a visualization tool that allows, for a certain depth and window size, to create a mask using the Large Foundation Model. Another option, by scrolling up and down the image, allows the user to go through all the depths of the image and create a mask for the defects.

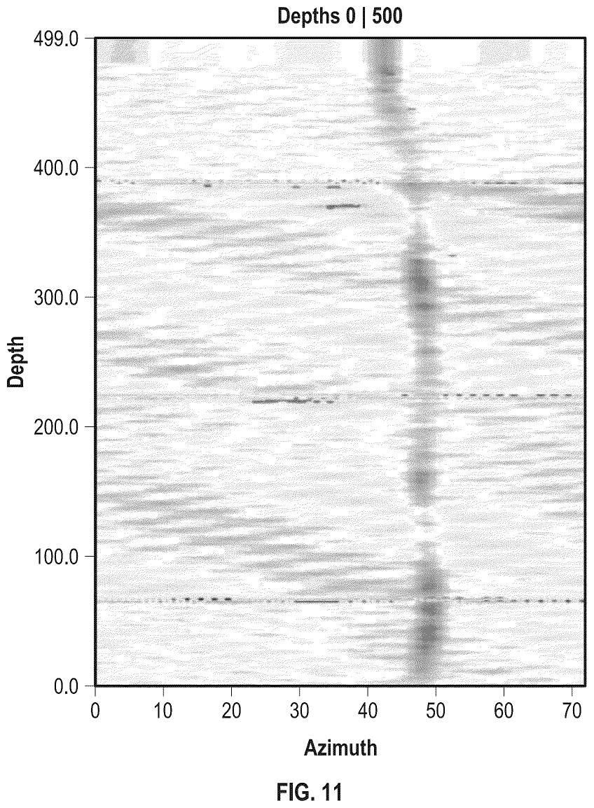

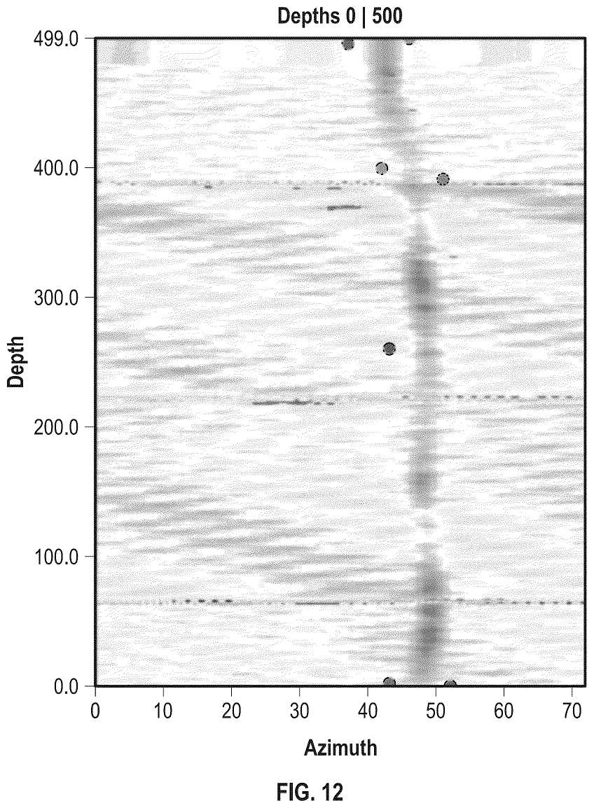

In embodiments, four main buttons have been created for this tool as well as a visualization area. FIG. 11 presents an example of a display, described above.

Another feature is added to the display that makes it clickable. By clicking on the plot, users can read and add points at the clicked positions. These points are used to create the enlarged mask around the defect. The latter will serve as an initialization for the mask that will be fine-tuned using the LFM, following the same procedure as described in the previous sections, which is the purpose of this tool.

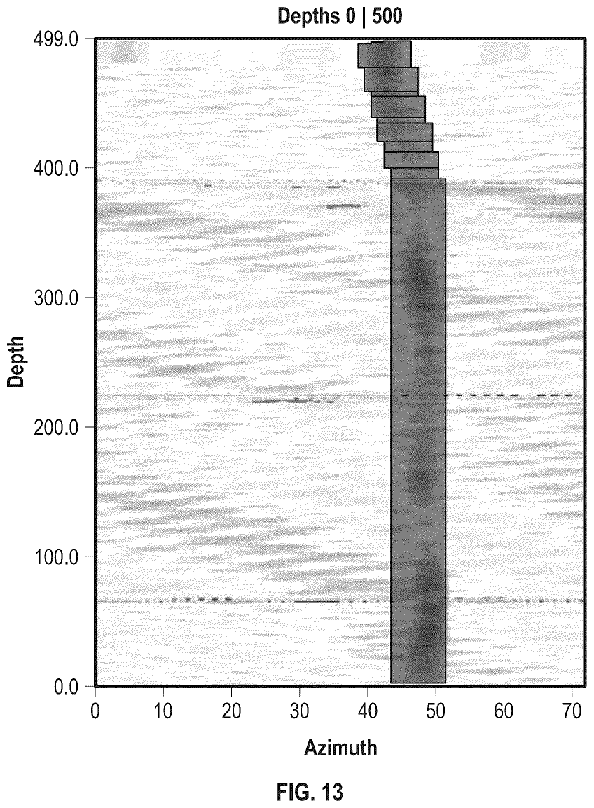

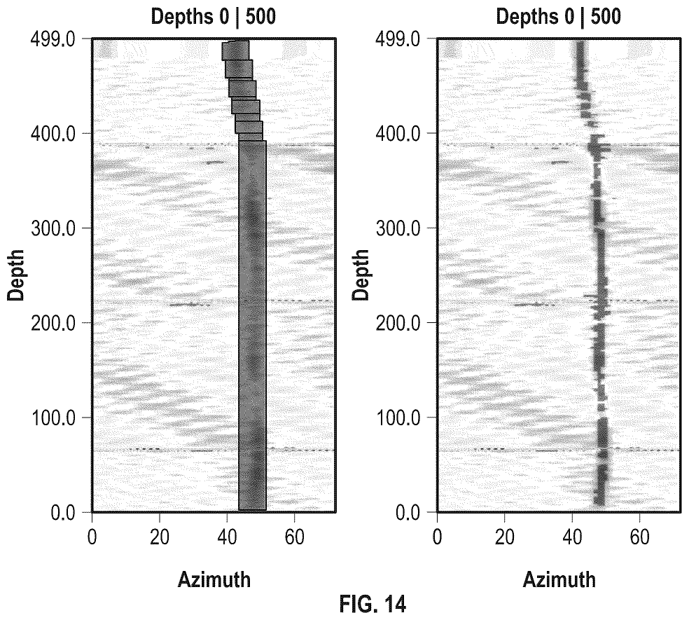

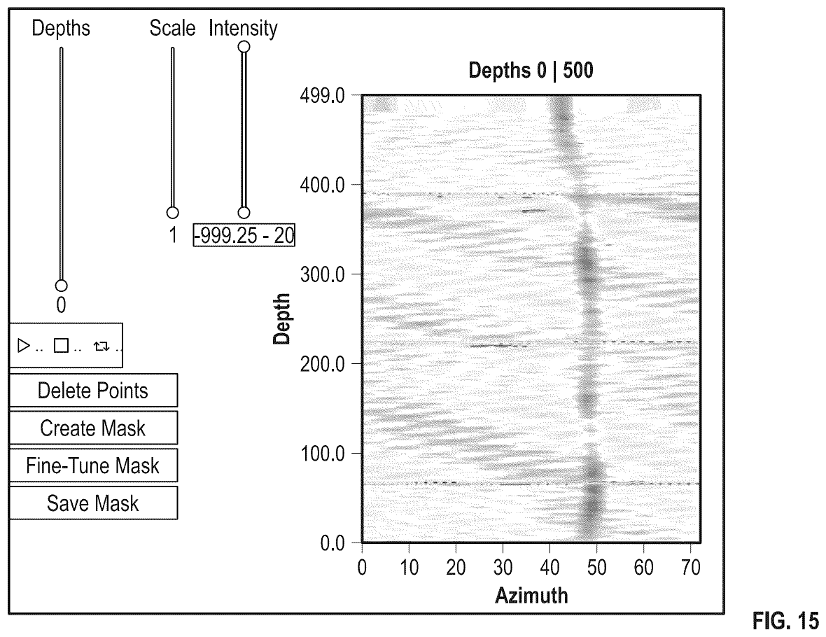

In embodiments, the user clicks on the points in a clockwise direction, as the polygon is defined by ordered points. To facilitate the annotation process, the four buttons described above are provided in the annotation tool:
The “Delete Points” button allows users to delete points if they want to start over or if they made an error in selecting a point.
The “Create Mask” button helps users to create a mask from the clicked points, assuming that there are at least four selected points, otherwise it arises an error. The corners of the mask will be defined by the chosen points. The mask will be displayed superimposed on the image, as illustrated in FIG. 13.
By clicking on the “Fine-tune Mask” button, users can generate a fine-tuned mask using the model, following the procedure described previously. The display will show two separate plots. The plot on the right will show the image with the manual mask, and the plot on the left will show the image with the fine-tuned mask, as illustrated in FIG. 14.
Finally, after scrolling and creating the mask along the image, users can save the mask by clicking the “Save Mask” button, which saves the created mask in a NumPy format. It will be saved in the same repository with the name “mask.npy”.

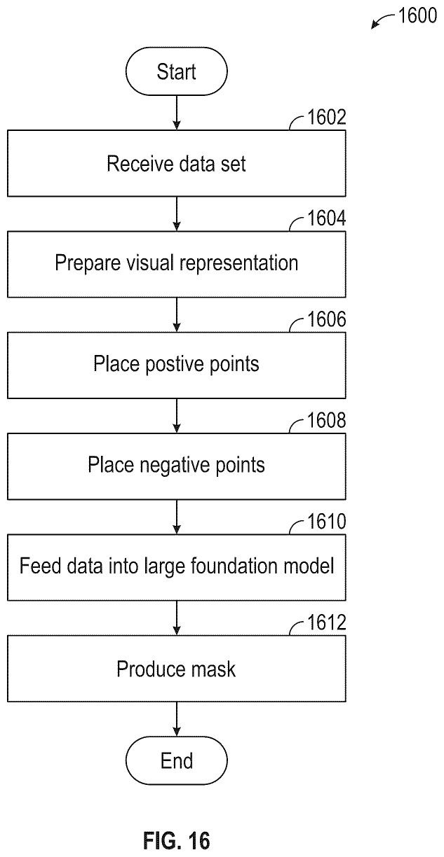

Referring to FIG. 16, a method 1600 in accordance with one example embodiment of the disclosure is presented. As will be understood, the method may be performed on a personal computer, server or cloud-based computer arrangement. The method includes receiving a set of data related to a piping formation at 1602. In some embodiments, the data received may be ultrasonic data as a non-limiting example. In other embodiments, the data may be previously completed analysis logs that are already annotated by an expert. The set of data may be stored in a digital format. The storage may be performed locally or the computer arrangement may be connected to the internet or a network for receiving the data from a remote location. At 1604, the method continues by preparing a visual representation of the data received at 1602. The visual representation may include display on a computer monitor, in one non-limiting example embodiment. At 1606, the method progresses to placing a set of positive data points on the visual representation of the data. The set may be a single point or multiple points. At 1608, the method also includes placing a set of negative data points on the visual representation of the data. As will be understood, both method steps 1606 and 1608 may be performed by an operator reviewing the visually represented data. Placement of the points may be through use of an annotation tool, as described above. In still further embodiments, placement of the positive data points and the negative points may be accomplished through use of an artificial intelligence computer program. At 1610, the method may further comprise feeding data of the positive data points, negative data points and visual representation into a Large Foundation Model. At 1612 the method continues with producing a mask with the Large Foundation Model, wherein the mask identifies defects in the data. The defects in the data may be related to corrosion or mechanical damage. As will be understood, the method may also include, for example, deletion of points already placed on the visual representation if such points are located in error. The mask may be saved into a non-volatile memory for storage and further review at the conclusion of the method. The storage may be performed on different medium, such as a compact disk, universal serial bus device, computer memory, server memory or other similar device.

With the method 1600 performed above, other embodiments are possible where the method would further comprise the ability to fine-tune a mask previously created in order to allow for better accuracy of the mask. For example, through experience, it has been determined that a specific defect, corrosion at a joint, occurs at a specific length of pipe in certain designs. Numerous previous masks may not have been accurate and shown the defect. The ability to fine-tune and recreate a mask that will display the defect would be of significant value.

In embodiments, the positioning of the negative points allows for limitations to be created on analysis. Such limitations on analysis may greatly speed up processing of the overall result, wherein data points outside of the bounds created by the negative points may be excluded from further analysis. To this end, placement of the negative points may, in essence, enhance calculation efficiency as the total data set for analysis is limited. Experience may be used in the placement of the negative points. For example, it may be apparent, in some situations, that defects that are over 1 inch wide are never encountered over repeated data generation events. To this end, placement of the negative points can easily define the overall amount of data analyzed as one inch negative from the positive indication point and one inch to the plus side of the positive data point.

Example embodiments of the disclosure are presented next. The example embodiments presented are not to be considered limiting. In one example embodiment, a method for automated defect recognition using a large foundation model is illustrated. The defects that are recognized are within or on a piping system. The piping system may be used as a conveyance for hydrocarbon materials in some non-limiting aspects. Embodiments may also be used for non-hydrocarbon fluids, such as water pipes or chemical fluid pipes used in refineries and general industrial processing. In one embodiment of the disclosure a method of automated defect recognition is disclosed. The method may comprise receiving a set of data related to a piping formation. The method may also comprise. The method may also comprise preparing a visual representation of the data. The method may also comprise placing at least one positive data point on the visual representation. The method may also comprise placing at least two negative data points on the visual representation. The method may also comprise feeding data of the at least one positive data point, the at least two negative data points and visual representation of the data into a Large Foundation Model. The method may also comprise producing a mask with the Large Foundation Model, wherein the mask identifies defects in the data.

In another example embodiment, the method may be performed wherein the data received is ultrasonic data.

In another example embodiment, the method may be performed wherein the data is a previously completed analysis log that has been previously annotated.

In another example embodiment, the method may be performed wherein the data is in a digital format.

In another example embodiment, the method may be performed wherein the data is stored on one of a non-volatile device, a computer server, a personal computer and a network.

In another example embodiment, the method may be performed wherein the visual representation is on a computer monitor.

In another example embodiment, the method may be performed wherein the placing of the at least one positive data point or the placing of the at least two negative data points is through an annotation tool.

In another example embodiment, the method may be performed wherein the placing of the at least one positive data point or the placing of the at least two negative data points is through an annotation tool is through use of an artificial intelligence computer program.

In another example embodiment, the method may be performed wherein the placing of the at least one positive data point or the placing of the at least two negative data points is through an annotation tool.

In another example embodiment, the method may be performed wherein the defects in the data are related to one of corrosion on the piping or mechanical damage of the piping.

In another example embodiment, the method may further comprise deleting at least one of the positive points and the negative points.

In another example embodiment, the method may further comprise saving the mask generated by the Large Foundation Model.

In another example embodiment, the method may be performed wherein the saving mask generated by the Large Foundation Model is to a memory arrangement.

In another example embodiment, an article of manufacture configured to contain a set of instructions that are readable by a computer is disclosed. The article of manufacture configured on a non-volatile memory. The set of instructions are configured to perform: receiving a set of data related to a piping formation, and preparing a visual representation of the data. The set of instructions further configured for placing at least one positive data point on the visual representation. The set of instructions further configured for placing at least two negative data points on the visual representation. The set of instructions further configured for feeding data of the at least one positive data point, the at least two negative data points and visual representation of the data into a Large Foundation Model. The set of instructions further configured for producing a mask with the Large Foundation Model, wherein the mask identifies defects in the data.

In another example embodiment, the article of manufacture may be configured wherein the set of instructions is further configured such that processing may be performed where the data received is ultrasonic data.

In another example embodiment, the article of manufacture may be configured wherein the set of instructions is further configured wherein the data is a previously completed analysis log that has been previously annotated.

In another example embodiment, the article of manufacture may be configured wherein the set of instructions is further configured to use the data when it is in a digital format.

In another example embodiment, the article of manufacture may be configured wherein the set of instructions is further configured to use the data when the data is stored on one of a non-volatile device, a computer server, a personal computer and a network.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may be varied in many ways. Such variations are not to be regarded as a departure from the disclosure, and all such modifications are intended to be included within the scope of the disclosure.

While embodiments have been described herein, those skilled in the art, having benefit of this disclosure, will appreciate that other embodiments are envisioned that do not depart from the inventive scope. Accordingly, the scope of the present claims or any subsequent claims shall not be unduly limited by the description of the embodiments described herein.

What is claimed is:

1. A method of automated defect recognition, comprising:
receiving a set of data related to a piping formation;
preparing a visual representation of the data;
placing at least one positive data point on the visual representation;
placing at least two negative data points on the visual representation;
feeding data of the at least one positive data point, the at least two negative data points and visual representation of the data into a Large Foundation Model;
producing a mask with the Large Foundation Model, wherein the mask identifies defects in the data.

2. The method according to claim 1, wherein the data received is ultrasonic data.

3. The method according to claim 1, wherein the data is a previously completed analysis log that has been previously annotated.

4. The method according to claim 1, wherein the data is in a digital format.

5. The method according to claim 4, wherein the data is stored on one of a non-volatile device, a computer server, a personal computer and a network.

6. The method according to claim 1, wherein the visual representation is on a computer monitor.

7. The method according to claim 1, wherein the placing of the at least one positive data point or the placing of the at least two negative data points is through an annotation tool.

8. The method according to claim 1, wherein the placing of the at least one positive data point or the placing of the at least two negative data points is through an annotation tool and an artificial intelligence computer program.

9. The method according to claim 1, wherein the placing of the at least one positive data point or the placing of the at least two negative data points is through an annotation tool.

10. The method according to claim 1, wherein the defects in the data are related to one of corrosion on the piping or mechanical damage of the piping.

11. The method according to claim 1, further comprising deleting at least one of the positive points and the negative points.

12. The method according to claim 1, further comprising: saving the mask generated by the Large Foundation Model.

13. The method according to claim 12, wherein the saving mask generated by the Large Foundation Model is to a memory arrangement.

14. An article of manufacture configured to contain a set of instructions that are readable by a computer, the article of manufacture configured on a non-volatile memory, the set of instructions including a method written to perform:
receiving a set of data related to a piping formation;
preparing a visual representation of the data;
placing at least one positive data point on the visual representation;
placing at least two negative data points on the visual representation;
feeding data of the at least one positive data point, the at least two negative data points and visual representation of the data into a Large Foundation Model;
producing a mask with the Large Foundation Model, wherein the mask identifies defects in the data.

15. The method according to claim 14, wherein the data received is ultrasonic data.

16. The method according to claim 14, wherein the data is a previously completed analysis log that has been previously annotated.

17. The method according to claim 14, wherein the data is in a digital format.

18. The method according to claim 17, wherein the data is stored on one of a non-volatile device, a computer server, a personal computer and a network.
